(19) United States
(12) Patent Application Publication
(10) Pub. No.: US 2021/0356746 A1
(43) Pub. Date: Nov. 18, 2021

(54) IMAGE DISPLAY APPARATUS WITH EXTENDED DEPTH OF FOCUS AND METHOD OF CONTROLLING THE SAME

(71) Applicant: KOREA INSTITUTE OF SCIENCE AND TECHNOLOGY, Seoul (KR)

(72) Inventor: Sung Kyu KIM, Seoul (KR)

(73) Assignee: KOREA INSTITUTE OF SCIENCE AND TECHNOLOGY, Seoul (KR)

(21) Appl. No.: 17/319,653

(22) Filed: May 13, 2021

(30) Foreign Application Priority Data
May 14, 2020 (KR) 10-2020-0057919

(51) Int. Cl. G02B 27/01; G02B 30/36

(52) U.S. Cl. CPC G02B 27/0172; G02B 30/36; G02B 2027/0187; G02B 2027/0127; G02B 2027/0134; G02B 27/0179

(57) ABSTRACT

The present disclosure relates to an image display apparatus with an extended depth of focus (DOF) and a method of controlling the same. The image display apparatus with an extended DOF includes a display unit, an optical element unit disposed to be spaced apart from a front surface of the display unit by a predetermined distance (D_{md}) and including a lens and a pinhole that has an opening portion (PDₘₗ), a main optics lens disposed to be spaced apart from a front surface of the optical element unit by a predetermined distance (Dₒ) and configured to form a convergence area of a virtual image on a pupil of an eye of a user, and a control unit that performs a control for extending a DOF with respect to the virtual image provided to the user.

### CROSS-REFERENCE TO RELATED APPLICATION

This application claims priority to and the benefit of Korean Patent Application No. 2020-0057919, filed on May 14, 2020, the disclosure of which is incorporated herein by reference in its entirety.

### BACKGROUND

### 1. Field of the Invention

The present disclosure relates to an image display apparatus with an extended depth of focus (DOF) and a method of controlling the same.

### 2. Discussion of Related Art

Conventional augmented reality or virtual reality head-mounted display (HMD) products may provide a stereoscopic image of a binocular parallax method but may not provide information on eye accommodation, thereby resulting in an obstacle to popularization because of fundamental problems such as eye fatigue and the blurring of images according to gaze depth. In addition, when information of eye focus adjustment is not provided, there is a difference in focus information between real information and virtual information, thereby generating image mismatch. Even the Microsoft HoloLens, which is one of the top commercial augmented reality display products, is not recommended to display a three-dimensional (3D) object within one meter because of providing a poor experience. However, in order to provide interaction with 3D images within a range of human hand motion (30 to 80 cm), support for a focus adjustment factor of the 3D image is essential.

Korean Patent Laid-Open No. 10-0617396 discloses a 3D image display apparatus that may provide two or more parallax images within a minimum diameter of a pupil of an eye. However, since the 3D image display apparatus has to include a parallax image providing unit having a laser source, an optical beam expander, and a light modulator, and a parallax image convergence area including pinholes, lenses, and the like in order to provide at least two parallax images in the pupil, there are problems in size and volume constraints. In addition, Korean Patent Laid-Open No. 10-1059763 discloses a 3D image display apparatus that satisfies a focus adjustment function by arranging light sources in vertical, horizontal, and diagonal directions using a light source element. However, there is a problem in commercialization because a projection optical system, which is basically required for enlarging an image and adjusting a focus, is large in volume.

In particular, lens and aperture conditions for forming a convergence area that minimizes the blur of parallax images are not specifically disclosed in the related art documents. Accordingly, there is a need for a method of controlling an image display apparatus such that a depth of focus (DOF) is extended to minimize eye fatigue and the blurring of images according to gaze depth.

### SUMMARY OF THE INVENTION

The present disclosure is directed to providing an image display apparatus with an extended depth of focus (DOF) and a method of controlling the same, allowing eye fatigue and the blurring of images according to gaze depth to be minimized.

According to an aspect of the present disclosure, there is provided a method of controlling an image display apparatus with an extended depth of focus (DOF), which includes a display unit, an optical element unit disposed to be spaced apart from a front surface of the display unit by a predetermined distance (D_{md}) and including a lens and a pinhole that has an opening portion (PDₘₗ), a main optics lens disposed to be spaced apart from a front surface of the optical element unit by a predetermined distance (Dₒ) and configured to form a convergence area of a virtual image on a pupil of an eye of a user, and a control unit that performs a control for extending a DOF with respect to the virtual image provided to the user. The control unit adjusts a size of the convergence area, which is formed from an image point of the virtual image, at a position of the pupil of the eye so that a size of a near position image blur of the image point, which is formed on a retina, at a most near accommodation position of the eye, is equal to a size of a far position image blur of the image point, which is formed on the retina, at a most far accommodation position of the eye.

The control unit may adjust the size of the convergence area, which is formed from the image point of the virtual image, at the position of the pupil of the eye so that a best position of the image point of the virtual image becomes an arithmetic mean position of the most near accommodation position of the eye and the most far accommodation position of the eye in units of diopters.

The control unit may adjust the size of the convergence area, which is formed from the image point of the virtual image, at the position of the pupil of the eye so that the size of each of the near and far position image blurs is within 20% of the same value as a size of an image blur due to diffraction.

The control unit may adjust the distance (D_{md}) between the front surface of the display unit and the optical element unit and/or a size of the pinhole of the optical element unit.

The most far accommodation position of the eye may be zero in units of diopters.

The size of the convergence area at the position of the pupil of the eye may be 2 mm or less.

A ratio of a distance between the optical element unit and the main optics lens and a distance between the main optics lens and the convergence area at the position of the pupil of the eye may range from 1.5 to 4.

The display unit may include at least one or more micro-displays, the lens and the pinhole of the optical element unit may be disposed to correspond to the micro-displays, and the control unit may form one or two or more convergence areas at the position of the pupil of the eye, wherein the two or more convergence areas may be adjacent parallax images.

The control unit may adjust the separation distance (D_{md}) between the display unit and the optical element unit to change a best position (D_{best}) of the image point of the virtual image.

The display unit may include at least two or more displays comprising a first display unit and a second display unit and, the optical element unit includes at least two or more optical element units comprising a first optical element unit and a second optical element unit, the most near accommodation position of the eye may include a first most near accommodation position of the eye and a second most near accommodation position of the eye, the most far accommodation position of the eye includes a first most far accommodation position of the eye and a second most far accommodation position of the eye, and the control unit may be configured to adjust a distance between a front surface of the first display unit and the first optical element unit and/or a size of a pinhole of the first optical element unit and a distance between a front surface of the second display unit and the second optical element unit and/or a size of a pinhole of the second optical element unit so that a size of a geometrical image blur of an image point, which is formed on the retina, at each of the first most near accommodation position of the eye and the first most far accommodation position of the eye is the same and a size of a geometrical image blur of an image point, which is formed on the retina, at each of the second most near accommodation position of the eye and the second most far accommodation position of the eye is the same, to adjust the size of the convergence area, which is formed from the image point of the virtual image, at the position of the pupil of the eye.

The control unit may control the first most far accommodation position of the eye to be equal to or less than the second most near accommodation position of the eye in units of diopters so that the entire DOF range is extended between the second most far accommodation position of the eye and the first most near accommodation position of the eye.

According to another aspect of the present disclosure, there is provided an image display apparatus with an extended depth of focus (DOF), the apparatus including a display unit, an optical element unit disposed to be spaced apart from a front surface of the display unit by a predetermined distance (D_{md}) and including a lens and a pinhole that has an opening portion (PD_{md}), a main optics lens disposed to be spaced apart from a front surface of the optical element unit by a predetermined distance (Dₒ) and configured to form a convergence area of a virtual image on a pupil of an eye of a user, and a control unit that performs a control for extending a DOF with respect to the virtual image provided to the user. The control unit adjusts a size of the convergence area, which is formed from an image point of the virtual image, at a position of the pupil of the eye so that a size of a near position image blur of the image point, which is formed on a retina, at a most near accommodation position of the eye, is equal to a size of a far position image blur of the image point, which is formed on the retina, at a most far accommodation position of the eye.

The display unit may have an array structure in which micro-displays are arranged adjacent to each other, and the optical element unit may have an array structure in which micro-lenses and pinholes, of which openings are adjustable, that correspond to the micro-displays are arranged adjacent to each other.

One or two or more convergence areas may be formed at a position of the pupil of the eye using the micro-displays and the micro-lenses, and the two or more convergence areas may be adjacent parallax images.

The optical element unit or the main optics lens may include a plurality of lenses.

The apparatus may further include a beam splitter disposed between the main optics lens and the pupil of the eye and configured to change a path of light, wherein the user may simultaneously observe a virtual image reflected from the beam splitter and a real-world image that has passed through the beam splitter.

The apparatus may further include a fine adjustment device configured to adjust the separation distance between the display unit and the optical element unit to change a best position (D_{best}) of the image point of the virtual image.

The apparatus may further include an eye-tracking system configured to provide focal distance information of the eye, wherein the control unit may adjust the separation distance (D_{md}) between the display unit and the optical element unit according to the focal distance information of the eye.

The apparatus may further include an eye-tracking system configured to provide focal distance information of the eye, wherein two virtual image positions (D_{best1} and D_{best2}) may be set and used, and the control unit may selectively adjust the separation distance (D_{md}) between the display unit and the optical element unit so that, among the two virtual image positions, a position close to a focal distance measured by the eye-tracking system is selected.

The display unit may include at least two or more displays, and each of the most near accommodation position of the eye and the most far accommodation position of the eye may include two or more.

The display unit may include a first display unit and a second display unit disposed perpendicular to the first display unit, and a beam splitter may be disposed between the first display unit and the second display unit.

The most near accommodation position of the eye may include a first most near accommodation position of the eye and a second most near accommodation position of the eye, the most far accommodation position of the eye may include a first most far accommodation position of the eye and a second most far accommodation position of the eye, a size of a geometrical image blur of an image point, which is formed on the retina, at each of the first most near accommodation position of the eye and the first most far accommodation position of the eye may be the same, and a size of a geometrical image blur of an image point, which is formed on the retina, at each of the second most near accommodation position of the eye and the second most far accommodation position of the eye may be the same.

The first most far accommodation position of the eye may be equal to or less than the second most near accommodation position of the eye in units of diopters so that the entire DOF range is extended between the second most far accommodation position of the eye and the first most near accommodation position of the eye.

The apparatus may further include an eye-tracking system configured to provide focal distance information of the eye, wherein the control unit may selectively operate a virtual image that is close to a focal distance of the eye according to the focal distance information of the eye.

The control unit may adjust the size of the convergence area, which is formed from the image point of the virtual image, at the position of the pupil of the eye so that a best position of the image point of the virtual image becomes an arithmetic mean position of the most near accommodation position of the eye and the most far accommodation position of the eye in units of diopters.

The control unit may adjust the size of the convergence area, which is formed from the image point of the virtual image, at the position of the pupil of the eye so that the size of each of the near and far position image blurs is within 20% of the same value as a size of an image blur due to diffraction.

A ratio of a distance between the optical element unit and the main optics lens and a distance between the main optics lens and the convergence area at the position of the pupil of the eye may range from 1.5 to 4.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other objects, features, and advantages of the present disclosure will become more apparent to those of ordinary skill in the art by describing exemplary embodiments thereof in detail with reference to the accompanying drawings, in which:

FIG. 1 is a schematic diagram illustrating a basic configuration of an image display apparatus with an extended depth of focus (DOF) according to an exemplary embodiment of the present disclosure;

FIGS. 2A and 2B are set of diagrams for describing a geometrical image blur in the image display apparatus with an extended DOF according to the embodiment of the present disclosure;

FIGS. 3A and 3B are set of graphs for calculating a size of the geometrical image blur and a best accommodation position of a virtual image required in an optical system according to a size of a specific DOF range and a size of a convergence area of the virtual image according to the embodiment of the present disclosure;

FIG. 4 is a diagram illustrating a process of designing a focal distance of a main optics lens according to the embodiment of the present disclosure;

FIG. 5 is a diagram for describing a method of determining a position of “D_{obj}” according to “D_{img}” according to the embodiment of the present disclosure;

FIG. 6 is a diagram illustrating a process of designing a size of an opening of an optical element unit according to an allowable size of a light bundle entering an eye lens according to the embodiment of the present disclosure;

FIG. 7 is a diagram illustrating a process of designing a field of view (FOV) in an eye position according to a combination of a display unit and the optical element unit according to the embodiment of the present disclosure;

FIG. 8 is a diagram illustrating a design of the image display apparatus with an extended DOF, which includes an eye, according to the exemplary embodiment of the present disclosure;

FIG. 9 is a diagram for describing a size (PDₘₗ) of an opening of a micro-lens and a size (PD_{eye}) of the convergence area in the image display apparatus with an extended DOF according to the embodiment of the present disclosure;

FIG. 10 is a graph illustrating the size of the geometrical image blur and a size of an image blur due to diffraction according to the size of the convergence area according to the embodiment of the present disclosure;

FIG. 11 is a diagram for describing a size of each of a near position image blur and a far position image blur according to the size of the convergence area according to the embodiment of the present disclosure;

FIG. 12 is a set of diagrams illustrating the results of a computational simulation of a spot diameter and modulation transfer function (MTF) characteristics in a retina under best conditions according to the embodiment of the present disclosure;

FIG. 13 is a graph illustrating the results of a computational simulation of a spatial frequency and MTF characteristics in the retina according to the size (PD_{eye}) of the convergence area according to the embodiment of the present disclosure;

FIG. 14 is a set of graphs illustrating best condition characteristics according to the DOF range according to the embodiment of the present disclosure.

FIGS. 15, 16A and 16B are diagrams illustrating a structure in which the FOV increases as a ratio of a distance between the optical element unit and the main optics lens according to the embodiment of the present disclosure and a distance between the main optics lens and the convergence area at the position of the pupil of the eye changes to 1.5 to 4;

FIGS. 17A and 17B are set of graphs for describing conditions for obtaining a best size of the optical element unit according to a designed DOF range when the optical system implements the same FOV according to the embodiment of the present disclosure;

FIG. 18 is a diagram illustrating a structure for an augmented reality (AR) application according to the embodiment of the present disclosure;

FIG. 19 is a diagram illustrating a configuration of an image display apparatus with an extended DOF according to another embodiment of the present disclosure;

FIG. 20 is a diagram illustrating a configuration of an image display apparatus with an extended DOF according to still another embodiment of the present disclosure;

FIGS. 21 and 22 are diagrams illustrating a configuration of an image display apparatus with an extended DOF according to yet another embodiment of the present disclosure; and

FIG. 23 is a diagram illustrating a configuration of an image display apparatus with an extended DOF according to yet another embodiment of the present disclosure.

### DETAILED DESCRIPTION OF EXEMPLARY EMBODIMENTS

Hereinafter, specific contents for implementing the present disclosure will be described in detail with reference to the accompanying drawings. In describing the present disclosure, when a detailed description of a related known function that is self-evident to those of ordinary skill in the art is determined as having the possibility of unnecessarily blurring the gist of the present disclosure, the detailed description thereof will be omitted.

The terms used herein are for the purpose of describing only specific embodiments and are not intended to limit the present disclosure. The singular form includes the plural form unless the context clearly dictates otherwise, and components that are distributed and implemented may be embodied in a combined form unless otherwise specified. In the present specification, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

The terms including ordinal numbers such as first and second used herein may be used to describe various components, but the components are not limited by the terms. The terms are used only for the purpose of distinguishing one component from another. For example, without departing from the scope of the present disclosure, a first component may be referred to as a second component, and similarly, the second component may be referred to as the first component.

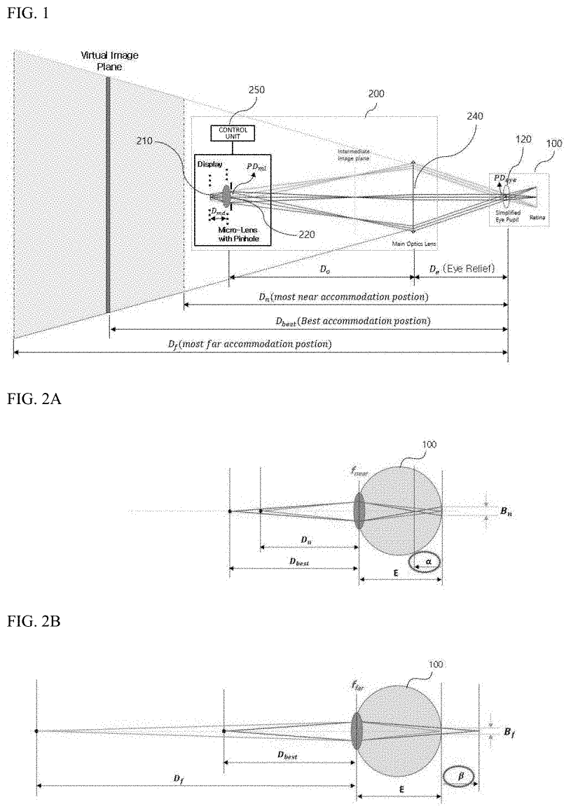

FIG. 1 is a schematic diagram illustrating a basic configuration of an image display apparatus with an extended depth of focus (DOF) according to an exemplary embodiment of the present disclosure.

Referring to FIG. 1, an image display apparatus 200 with an extended DOF of the present disclosure includes a display unit 210 configured to provide an image, an optical element unit 220 disposed to be spaced apart from the display unit 210 by a predetermined distance, and a main optics lens 240 disposed to be spaced apart from the optical element unit 220 by a predetermined distance and configured to form a convergence area PDeye of a virtual image on a pupil 120 of an eye 100 of a user. In addition, the image display apparatus 200 with an extended DOF may further include a control unit 250 that performs control for extending a DOF with respect to the virtual image provided to the user.

The display unit 210 may be a self-luminous micro display panel corresponding to an organic light-emitting diode (OLED) or micro light-emitting diode (LED), or a passive display panel corresponding to a liquid crystal display (LCD), a liquid crystal on silicon (LCoS), or a digital micro-mirror device (DMD).

The optical element unit 220 is configured to spatially divide the image and may include a pinhole array or an array of lenses such as micro-lenses.

The main optics lens 240 may converge the image provided from the display unit 210 on the pupil 120 of the eye 100 and may include one or more of a plurality of lenses. Generally, a width of the pupil of the eye ranges from 2 mm to 8 mm according to surrounding brightness.

For the detailed description of the basic configuration of the image display apparatus including the display unit 210, the optical element unit 220, and the main optics lens 240, the configuration disclosed in the inventor's Patent Publication No. 10-1919486 may be referenced.

An image formed in the display unit 210 passes through the optical element unit 220 to form an intermediate image and passes through the main optics lens 240 to form an image of the optical element unit 220, which is defined as the convergence area, on the pupil of the eye. When there is an opening after the micro-lens of the optical element unit 220, the convergence area refers to an image of the opening. In addition, through this, an image is formed on a retina.

A best accommodation position of the virtual image, which is determined by the image display apparatus with an extended DOF, perceived by an observer is expressed as “D_{best}” in FIG. 1. A difference Dₙ−D_{f} in units of diopter between a most near accommodation position Dₙ and a most far accommodation position D_{f}, at which a focus is adjustable without perceiving the blurring of the virtual image by the observer, is referred to as a DOF range of an optical system.

The necessity of extending the DOF in the present disclosure will now be described.

In a case in which a DOF is small, when an augmented reality or virtual reality optical system is used, eye fatigue occurs due to vergence-accommodation conflict (VAC). A three-dimensional image (3D) through the image display apparatus with an extended DOF is represented before and after a virtual image plane. That is, only when the DOF is sufficiently large, an image, from an image at an infinite distance to a proximity image (250 to 500 mm), may be represented without blurring.

In addition, when an augmented reality optical system is used, a virtual image and an actual object have to be clearly observed at the same time. Even when the observer focuses on the actual object having a depth different from that of the virtual image, the observer should be able to clearly see the virtual image.

In order to extend the DOF, the control unit 250 may control an opening portion PDₘₗ of a pinhole when the optical element unit 220 includes the micro-lens and the pinhole. Specifically, in order to change the best accommodation position D_{best} or the most near and far accommodation positions Dₙ and D_{f} of the eye of the virtual image in a predetermined DOF range, a separation distance D_{md} between the display unit 210 and the micro-lens of the optical element unit 220 may be finely adjusted using a fine adjustment device (not shown). The fine adjustment device that may be used in the present disclosure includes a piezoelectric element, a voice coil motor (VCM), or the like.

In order to adjust the DOF range at the predetermined best accommodation position of the virtual image, the pinhole, which is adjacent to the micro-lens of the optical element unit 220 and determines a size of the opening portion, is electrically controlled. As the electrically controlled pinhole, a liquid crystal element capable of electrically controlling a transmission unit may be used. Such an example describes the case in which the control unit electrically adjusts a separation distance between the display unit and the micro-lens and a size of the opening portion of the lens, but only one of the separation distance and the size may be controlled by the control unit, and another one thereof may be fixed and used or controlled mechanically.

A method of providing the virtual image to the user using the image display apparatus with an extended DOF according to the exemplary embodiment of the present disclosure will be described with reference to FIG. 1. An image, which is displayed by the display unit 210, forms a virtual image on an intermediate image plane located between the optical element unit and the main optics lens due to the optical element unit 220. The convergence area is formed in the pupil of the eye, which is spaced apart from the main optics lens 240 by a separation distance Dₑ, by the main optics lens 240 disposed to be spaced apart from the intermediate image by a predetermined distance D_{obj}. The optical system of the present disclosure is designed so that the virtual image is focused on the retina of the eye of the user. At this point, a best focus adjustment position perceived by the eye is the virtual image plane. Although only eye optical system of one eye is described in the embodiment of the present disclosure, an image may be provided equally to both eyes, or a 3D virtual image may be provided to the user by providing different parallax images to both eyes.

FIGS. 2A and 2B are set of diagrams for describing a geometrical image blur in the image display apparatus with an extended DOF according to the embodiment of the present disclosure. FIG. 2A illustrates a case in which an image point at the best accommodation position D_{best} is observed from the eye that is focused on the most near accommodation position Dₙ. At this point, the focus is formed to deviate by a predetermined length α within a length range E of the eye 100, and a size of the geometrical image blur in the retina is equal to “Bₙ.”

FIG. 2B illustrates a case in which the image point at the best accommodation position D_{best} is observed from the eye that is focused on the most far accommodation position D_{f}. At this point, the focus is formed to deviate by a predetermined length β outside the length range E of the eye 100, and a size of the geometrical image blur in the retina is equal to “B_{f}.”

Preferably, when the focus is adjusted at the most near accommodation position Dₙ of the eye and the most far accommodation position D_{f} of the eye by an eye lens (eyeball lens), the control unit 250 may set a size Bₙ of a near position image blur and a size B_{f} of a far position image blur in the retina of the ideal image point to be the same.

Accordingly, the geometrical image blur is further reduced at any focus adjustment between the most near accommodation position Dₙ of the eye and the most far accommodation position D_{f} of the eye, and when the eye lens is adjusted to be focused on the best accommodation position D_{best} of the virtual image, the blur has a minimum value (ideally 0).

In this case, when a size of an image point blur, in a case in which the eye lens is focused at the most near accommodation position Dₙ of the eye or the most far accommodation position D_{f} of the eye, is within an acceptable image quality, these two positions define the DOF range.

Preferably, the control unit 250 may control a virtual image forming position to be equal to an arithmetic mean position of the most near accommodation position Dₙ of the eye and the most far accommodation position D_{f} of the eye in units of diopters. That is, when the most near accommodation position Dₙ of the eye or the most far accommodation position D_{f} of the eye of the DOF range is determined, the virtual image forming position of the image display apparatus with an extended DOF is the arithmetic mean value in units of diopters. That is, D_{best}=(Dₙ+D_{f})/2.

The size of the image point blur in the retina at the most near accommodation position Dₙ of the eye and the most far accommodation position D_{f} of the eye increases linearly in proportion to a size PD_{eye} of the convergence area as the image point of the virtual image passes through the optical system and increases linearly as the DOF range in a preset diopter unit increases. This is because a geometrical size of the image point increases as a difference increases between a focal distance of the eye lens when the eye lens is focused at the best accommodation position D_{best} of the virtual image and the focal distance of the eye lens when the eye lens is focused at the most near accommodation position Dₙ of the eye.

In this case, it is preferable that the eye lens is adjusted to be focused on the virtual image between the most near accommodation position Dₙ of the eye and the most far accommodation position D_{f} of the eye to clearly see the virtual image by setting the most far accommodation position D_{f} of the eye to infinity (“0” in units of diopters).

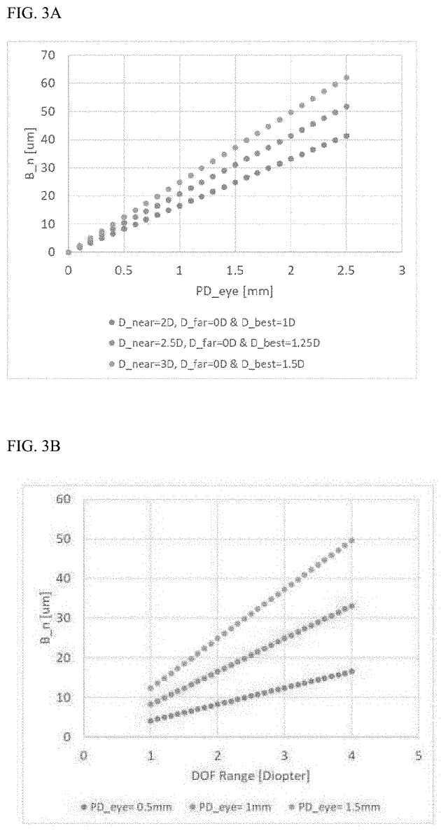

FIGS. 3A and 3B are set of graphs for calculating the size of the geometrical image blur and the best accommodation position of the virtual image required in the optical system according to the size of the specific DOF range and the size of the convergence area of the virtual image according to the embodiment of the present disclosure. FIG. 3A illustrates a characteristic of the size (Bₙ or B_{f}) of the geometrical image blur of the image point for DOF ranges according to the size of the convergence area, and FIG. 3B illustrates the characteristic of the size (Bₙ or B_{f}) of the geometrical image blur of the image point for the DOF ranges when the size of the convergence area is constant.

Referring to FIG. 3A, when the most far accommodation position D_{f} of the eye is set to infinity (“0” in units of diopters), and the DOF ranges are 2 diopters, 2.5 diopters, and 3 diopters, the best accommodation position D_{best} of the virtual image at the DOF ranges are respectively 1, 1.25, and 1.5 diopters, which are the arithmetic mean values of the most near accommodation position Dₙ of the eye and the most far accommodation position D_{f} of the eye.

The size PD_{eye} of the convergence area in which the image point of the virtual image is formed in the pupil of the eye in the defined DOF range increases linearly in proportion to the maximum size of the geometrical image blur on the retina, that is, the size Bₙ or B_{f} of the far or near position image blur. Accordingly, when the DOF range is defined, it is preferable to reduce the size PD_{eye} of the convergence area in order to reduce the geometrical image blur.

Referring to FIG. 3B, it can be seen that, when the size PD_{eye} of the convergence area is constant, as the DOF range increases, the size Bₙ or B_{f} of the far or near position image blur increases linearly.

A design method for optimizing the image display apparatus with an extended DOF according to the present disclosure will be described in detail as follows.

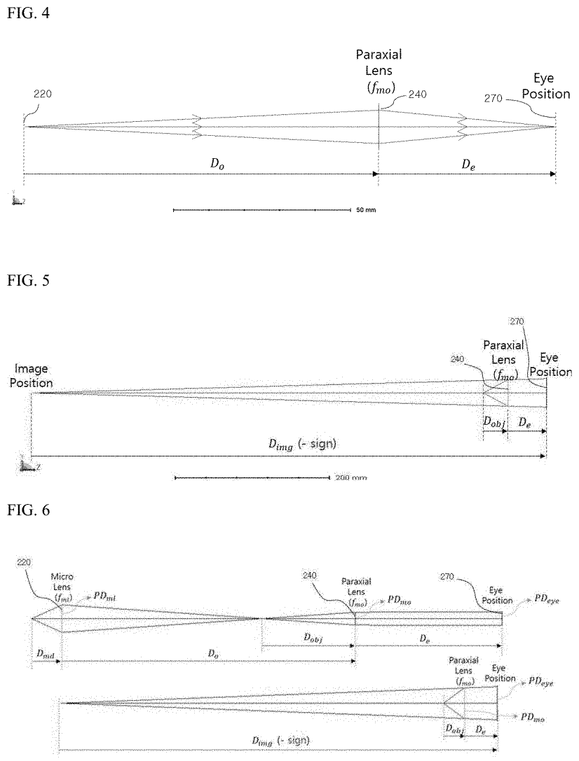

In order to achieve the purpose of the present disclosure, in the image display apparatus with an extended DOF, a focal distance of each optical element, a separation distance between the optical elements, and a depth at which the virtual image is formed should satisfy geometrical relationships illustrated in FIGS. 4 to 7. These may be expressed mathematically by relational expressions of Equations 1 to 9.

First, FIG. 4 is a diagram illustrating a process of designing the focal distance of the main optics lens according to the embodiment of the present disclosure.

Referring to FIG. 4 along with FIG. 5 and FIG. 6, the image display apparatus with an extended DOF may be designed such that the image point is set at a best position within a predetermined DOF range and the size thereof is minimized By designing a distance Dₒ between the optical element unit 220 and the main optics lens 240 to be greater than a distance Dₑ between the main optics lens 240 and the convergence area 270, a field of view (FOV) of the optical system seen by the observer may be increased, and the size of the image point at an eye position may be reduced in proportion thereto.

When the distance Dₒ between the optical element unit 220 and the main optics lens 240 and the distance Dₑ between the main optics lens 240 and the convergence area 270 are determined, a focal distance fₘₒ of the main optics lens 240 is determined by the image equation relationship of Equation 1. In the exemplary embodiment, when “Dₒ” becomes two times “Dₑ,” Equation 2 is satisfied.

At this point, between the eye and the optical system, the distance Dₑ between the main optics lens 240 and the convergence area 270 may be designed in consideration of user convenience, and conditions in which the FOV of the optical system is doubled and a light size of a point light source in the pupil is ½ times smaller may be considered.

$$\begin{matrix}\frac{1}{{f}_{mo}} = \frac{1}{{D}_{e}} + \frac{1}{{D}_{o}} {f}_{mo} = \frac{{D}_{e} \times {D}_{o}}{{D}_{e} + {D}_{o}} & ( Equation 1 ) \\ If 2 {D}_{e} = {D}_{o} , {f}_{mo} = \frac{2}{3} {D}_{e} & ( Equation 2 )\end{matrix}$$

FIG. 5 is a diagram for describing a method of determining a position of “D_{obj}” according to “D_{img}” according to the embodiment of the present disclosure.

Referring to FIG. 5, “D_{img}” refers to the position of the virtual image formed at a position of the eye lens, and “D_{obj}” is a depth at which virtual image information of the display is geometrically formed into an image by the micro-lens and is a distance of a depth position, at which an intermediate virtual image is formed, set from the main optics lens. “D_{obj}” may be calculated as follows.

$$\frac{1}{{f}_{mo}} = \frac{1}{{D}_{obj}} + \frac{1}{{D}_{e} + {D}_{img}} {D}_{obj} = \frac{{f}_{mo} ( {D}_{e} + {D}_{img} )}{( {D}_{e} + {D}_{img} ) - {f}_{mo}} \qquad ( Equation 3 )$$

FIG. 6 is a diagram illustrating a process of designing the size of the opening of the optical element unit according to an allowable size of a light bundle entering the eye lens according to the embodiment of the present disclosure.

Referring to FIG. 6, the size PD_{eye} of the convergence area may be calculated as follows.

$$\begin{matrix}{PD}_{ml} \text{:} ( {D}_{o} - {D}_{obj} ) = {PD}_{mo} \text{:} {D}_{obj} {PD}_{mo} = \frac{{D}_{obj}}{{D}_{o} - {D}_{obj}} {PD}_{ml} & ( Equation 4 ) \\ \vert {D}_{img} \vert \text{:} {PD}_{eye} = ( \vert {D}_{img} \vert - {D}_{e} ) \text{:} {PD}_{mo} {PD}_{eye} = \frac{\vert {D}_{img} \vert}{\vert {D}_{img} \vert - {D}_{e}} {PD}_{mo} & ( Equation 5 ) \\ {PD}_{eye} = \frac{\vert {D}_{img} \vert * {D}_{obj}}{( \vert {D}_{img} \vert - {D}_{e} ) * ( {D}_{o} - {D}_{obj} )} {PD}_{ml} & ( Equation 6 )\end{matrix}$$

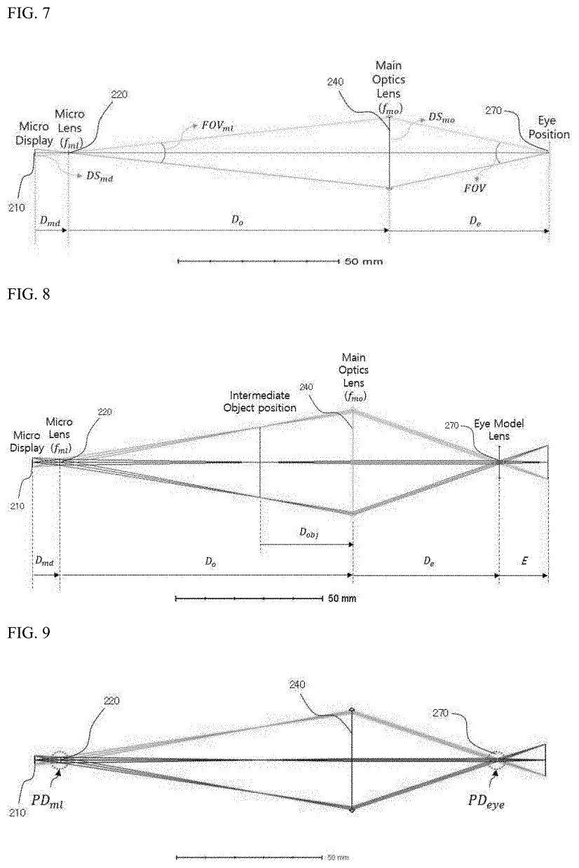

FIG. 7 is a diagram illustrating a process of designing a FOV in the eye position according to a combination of the display unit and the optical element unit according to the embodiment of the present disclosure.

Referring to FIG. 7, the FOV of the eye position may be calculated as follows.

$$\begin{matrix}\frac{1}{{D}_{mo}} + \frac{1}{{D}_{o} - {D}_{obj}} = \frac{1}{{f}_{mo}} {D}_{obj} = \frac{{f}_{mo} * ( {D}_{o} - {D}_{obj} )}{( {D}_{o} - {D}_{obj} ) - {f}_{ml}} & ( Equation 7 ) \\ {D}_{md} \text{:} {DS}_{md} = {D}_{o} \text{:} {DS}_{mo} {DS}_{mo} = \frac{{D}_{o}}{{D}_{md}} {DS}_{md} & ( Equation 8 ) \\ {POV}_{md} = 2 {tan}^{- 1} ( \frac{{DS}_{md}}{2 * {D}_{md}} ) , POV = 2 {tan}^{- 1} ( \frac{{DS}_{md}}{2 * {D}_{o}} ) & ( Equation 9 )\end{matrix}$$

FIG. 8 is a diagram illustrating a design of the image display apparatus with an extended DOF, which includes an eye, according to the exemplary embodiment of the present disclosure.

Referring to FIG. 8, a case in which the most near accommodation position Dₙ of the eye and the most far accommodation position D_{f} of the eye are 3 diopters and 0 diopters, respectively, and the best accommodation position D_{best} of the virtual image is 1.5 diopters is considered as the embodiment. At this point, the size of the image blur at the position of the retina of the eye may be calculated according to the size of the convergence area, which is formed from the image point of the virtual image, at a position of the pupil of the eye.

In detail, each parameter of the image display apparatus that generates the virtual image may be set as follows. The distance Dₒ between the optical element unit 220 and the main optics lens 240 may be set to 100 mm, the distance Dₑ between the main optics lens 240 and the convergence area 270 of the eye may be set to 50 mm, the focal distance fₘₒ of the main optics lens may be set to 33.3 mm, a focal distance fₘₗ of a lens of the optical element unit 220 may be set to 8 mm, and an effective distance D_{md}, between the display unit 210 and the optical element unit 220, for forming a virtual image in 1.5 diopters (666.7 mm) at the position of the eye, may be set to 9.06 mm.

At this point, each parameter is set as follows using a simple eye model. The simple eye model refers to an eye model, which is composed of an ideal lens (eye lens) and a retina disposed to be spaced apart from the ideal lens by a predetermined distance E and includes a substance therebetween having a refractive index of 1 (equal to that of air).

In the simple eye model, a distance between the eye lens and the retina of the eye may be set to 16.535 mm. In addition, for a focal distance of the eye lens according to the focus adjustment of the eye, a focal distance f_{best} of the eye lens when focusing on a best position (1.5 diopters) of the virtual image may be set to 16.1348 mm, a focal distance fₙ of the eye lens when focusing on a most near position of the DOF range may be set to 15.7535 mm, and a focal distance f_{f} of the eye lens when focusing on a most far position of the DOF range may be set to 16.535 mm.

Optimized variable parameters are set as follows. When the optical element unit is a micro-lens, the size PD_{eye} of the convergence area that is generated from the image point of the virtual image is determined according to a size PDₘₗ of the opening. In the present embodiment, an optical system is used in which a ratio of the distance Dₒ between the optical element unit 220 and the main optics lens 240 and the distance Dₑ between the main optics lens 240 and the convergence area 270 is 2:1 so that a ratio of the size PDₘₗ of the opening of the micro-lens and the size PD_{eye} of the convergence area is 2:1. As the ratio of the distance Dₒ and the distance Dₑ increases, the smaller size PD_{eye} of the convergence area may be formed at the same size PDₘₗ, and the FOV of the virtual image may be designed to be great.

The control unit 250 of FIG. 1 may change a depth extension and a best virtual image forming depth. For example, when the change of the best virtual image forming depth is described with reference to Equation 7, the focal distance fₘₗ of the optical element unit 220 disposed adjacent to the display unit 210 and the separation distance Dₒ between the optical element unit 220 and the main optics lens 240 have been determined. Thus, in order to adjust the separation distance D_{obj} between the intermediate image plane and the main optics lens, the separation distance D_{md} between the display unit and the optical element unit is adjusted (as a reference, in the case in which the focal distance fₘₒ of the main optics lens and the separation distance Dₑ between the main optics lens and the eye are determined, the position D_{img} of the virtual image plane seen from the eye may be adjusted by adjusting the separation distance D_{obj} between the intermediate image plane and the main optics lens according to the relational expression of Equation 3). The separation distance D_{md} between the display unit and the optical element unit may be controlled using, for example, a micro-distance adjustment device (a piezoelectric element, a VCM, or the like) that is controlled by the control unit. Alternatively, the separation distance D_{md} may be adjusted through a feedback of a focal depth of the eye by an eye-tracking system or through a set virtual image depth.

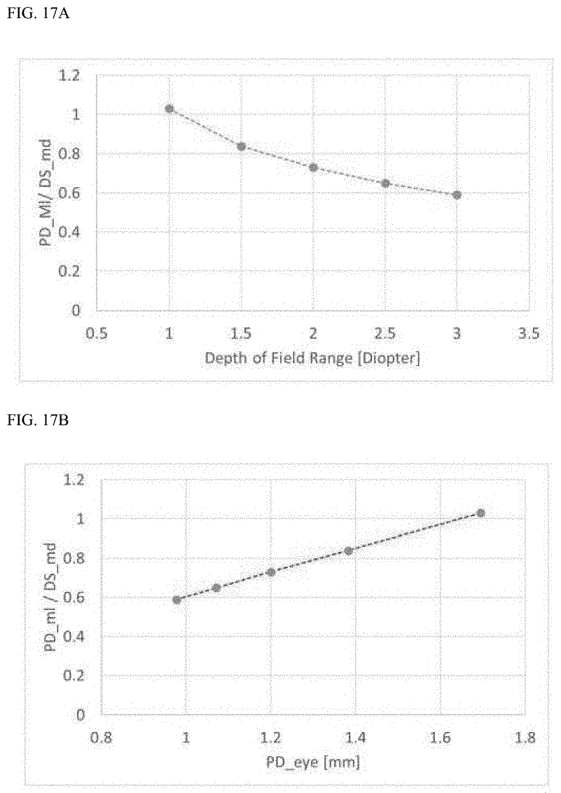

Alternatively, the DOF range may be adjusted using the control unit. As shown in FIG. 17 and a best condition data characteristic table associated with FIG. 17, in order to increase the DOF range, the size of the convergence area of the virtual image formed on the eye lens of the eye should be reduced. To achieve this, the size PDₘₗ of the opening of the micro-lens (when the optical element unit is the micro-lens) should be reduced in comparison with a display size DS_{md}. Thus, for the optical element unit, an optical element configured to adjust transparency according to an electrical signal, such as a liquid crystal element, is disposed adjacent to the micro-lens, and the opening portion disposed adjacent to the micro-lens is controlled according to the determined DOF by the control unit. Alternatively, when a predetermined DOF range is used, and the control unit controls only a formation position of the virtual image plane, a pinhole having a fixed opening portion may be disposed adjacent to the micro-lens.

FIG. 9 is a diagram for describing the size PDₘₗ of the opening of the micro-lens and the size PD_{eye} of the convergence area in the image display apparatus with an extended DOF according to the embodiment of the present disclosure.

Results obtained by experimenting with the image display apparatus with an extended DOF according to the embodiment using Zemax software are analyzed with reference to FIG. 9 as follows.

According to the embodiment, the image display apparatus with an extended DOF may be set such that the virtual image is located at a position at which the best accommodation position D_{best} of the virtual image is 1.5 diopters (666.7 mm) from the position of the pupil of the eye. At this point, it is possible to compare a size of the geometrical image blur when a focal position of the eye is changed and a size of an image blur due to diffraction. The key parameter for optimizing the optical system is the size PDₘₗ of the opening of the micro-lens, and accordingly, the size PD_{eye} of the convergence area at the position of the pupil of the eye of the optical system is determined.

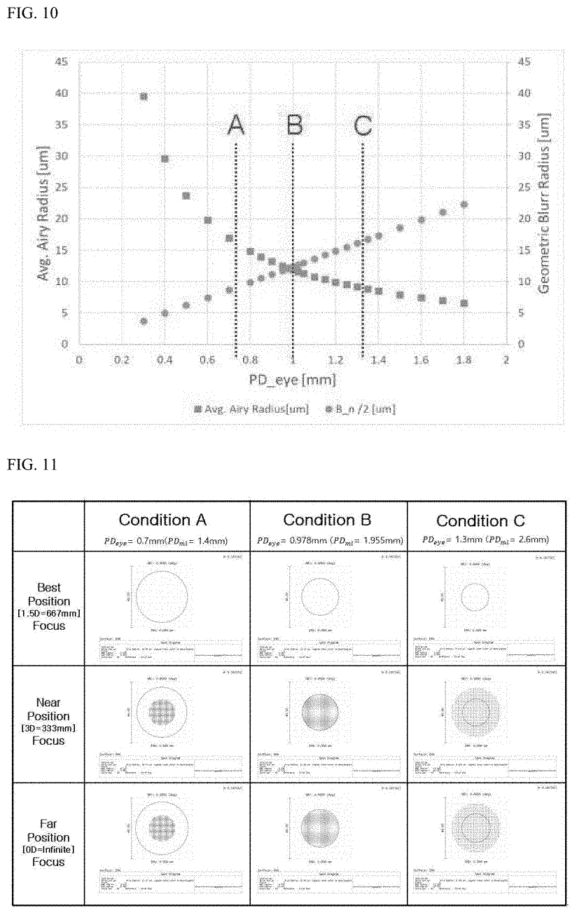

FIG. 10 is a graph illustrating the size of the geometrical image blur and the size of the image blur due to the diffraction according to the size of the convergence area according to the embodiment of the present disclosure, and FIG. 11 is a diagram for describing the size of each of the near position image blur and the far position image blur according to the size of the convergence area according to the embodiment of the present disclosure.

Referring to FIGS. 9 to 11, in the case in which the optical element unit is a micro-lens, as the size PDₘₗ of the opening increases, the size PD_{eye} of the convergence area determined according to the ratio of the distance Dₒ and the distance Dₑ of the optical system increases. In addition, when the size PD_{eye} of the convergence area increases, a geometrical blur in the retina under the conditions in which the eye lens is focused on the extreme positions (3 diopters and 0 diopters in the present embodiment) within the DOF range increases. On the other hand, the size of the image blur due to diffraction is reduced as the size PD_{eye} of the convergence area increases.

Thus, there is the size PD_{eye} of the convergence area that the size of the geometrical image blur and the size of the image blur due to diffraction are the same. These conditions are the optimum conditions of the size PDₘₗ of the opening or the size PD_{eye} of the convergence area satisfying the DOF range of the optical system. Referring to FIG. 10, in the present embodiment, the size of the geometrical image blur is 12.13 μm which is equal to the size of the image blur due to diffraction at the condition of size PD_{eye} of convergence area=0.978 mm (or “PDₘₗ”=1.955 mm).

FIG. 11 illustrates, by way of example, sizes of the image blur at a best position, a near position, and a far position according to sizes of three convergence areas (A, B, and C) in FIG. 10.

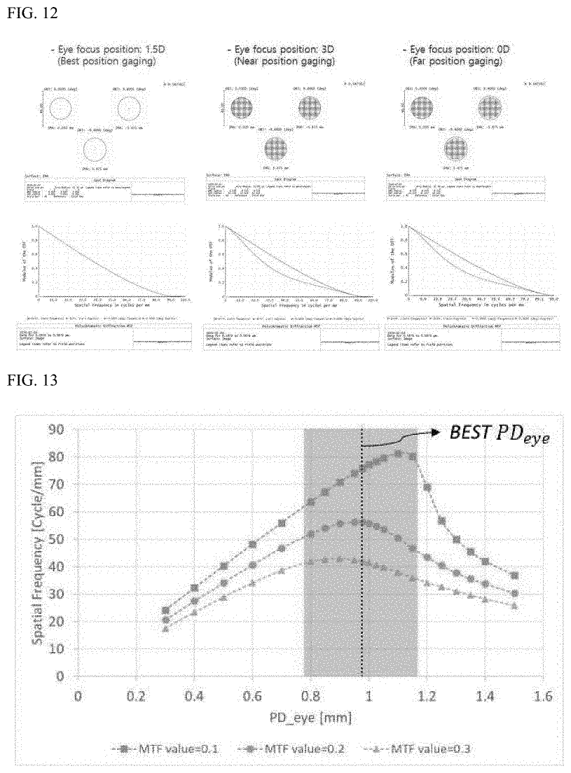

FIG. 12 is a set of diagrams illustrating the results of a computational simulation of a spot diameter and MTF characteristics in the retina under best conditions according to the embodiment of the present disclosure.

Referring to FIG. 12, key optimum conditions in the embodiment of the present disclosure may include size PD_{eye} of convergence area=0.9776 mm (size PDₘₗ of opening of optical element unit=1.9552 mm), size Bₙ of near position image blur/2=size B_{f} of far position image blur/2=12.125 μm, and size of image blur due to diffraction=12.12 μm.

FIG. 12 illustrates the results of a computational simulation of a spot diameter and MTF characteristics in the retina when focal positions of the eye are 1.5D (best position gaging), 3D (near position gaging), and 0D (far position gaging) in this order from the left.

When the focus of the eye is adjusted to an optimum depth which is the virtual image plane of the image display apparatus with an extended DOF according to the present disclosure, an ideal geometrical size of a spot is zero, and an MTF value according to a spatial frequency is equal to a diffraction limit value (refer to the data on the farthest left side). In addition, it can be seen that, in a case in which the eye is focused at a near position depth and a far position depth of the DOF range designed by the present disclosure, the ideal geometrical size of the spot is the same as a size of an Airy disk due to diffraction. In this case, the MTF characteristics according to the spatial frequency is slightly reduced further than the diffraction limit value (in particular, in an intermediate spatial frequency region), but there is no significant difference in a region in which the MTF, which is a limit region of the optical system, is 0.3 or less. Accordingly, it can be seen that, in the image display apparatus with an extended DOF according to the present disclosure, even when the eye is focused at any depth within the DOF range, the deterioration of image quality is hardly perceived by the eye and a clear virtual image is displayed.

However, the size PD_{eye} of the convergence area, at which a best spatial frequency of the MTF is provided, is changed within 0.1 to 0.3 (or 10% to 30%) based on the MTF value. Accordingly, it is preferable that the size PD_{eye} of the convergence area is set in a range of +−20% of the size PD_{eye} of the best convergence area. A final value of the size PD_{eye} of the convergence area needs to be set in consideration of a display resolution, a FOV, or the like.

FIG. 13 is a graph illustrating the results of a computational simulation of a spatial frequency and MTF characteristics in the retina according to the size PD_{eye} of the convergence area according to the embodiment of the present disclosure.

Referring to FIG. 13, a best position of the size PD_{eye} of the convergence area is formed at a value in which the size of the image blur due to diffraction matches the size of the geometrical image blur. However, a difference may occur in a value of the size PD_{eye} of the convergence area, which is best within the DOF determined for each spatial frequency of the MTF. At this point, even when the best value of the size PD_{eye} of the convergence area is different, the MTF value does not decrease sensitively in a region in which the spatial frequency is low.

Thus, a range of the MTF value for a criterion to be determined needs to be determined, which is exemplarily described as follows. The MTF is less than or equal to 0.15 based on a point spread function (PSF) Rayleigh criterion. The MTF is less than or equal to 0.09 based on an extended source criterion and a PSF convolution criterion. A reference MTF value is set within a range of 0.1 to 0.3 including a Rayleigh criterion in consideration of an extended source, and within this range, the size PD_{eye} of the convergence area including a best MTF value is within approximately +/−20% of the size PD_{eye} of the best convergence area.

As shown in FIG. 13, for the DOF range designed by the present embodiment, the size of the convergence area is determined as one (“PD_{eye}”=0.978 mm in the present embodiment) at the position of the eye in which the geometrical image blur and an Airy disk due to diffraction are the same at a far position DOF and a near position DOF. However, in the present embodiment, a spatial frequency having the MTF value in the range of 0.1 to 0.3 is not the largest in the size of the convergence area determined in this way, and the size of the convergence area that may express the maximum value of the spatial frequency varies according to the selected MTF value in the range of 0.1 to 0.3. Thus, it is preferable to determine the size of the convergence area in the range that may express more than 80% of the highest resolution (maximum spatial frequency), and when this is expressed by the size of the convergence area, the size of the convergence area becomes within approximately +−20% of the size PD_{eye} of the optimum convergence area set by the present disclosure.

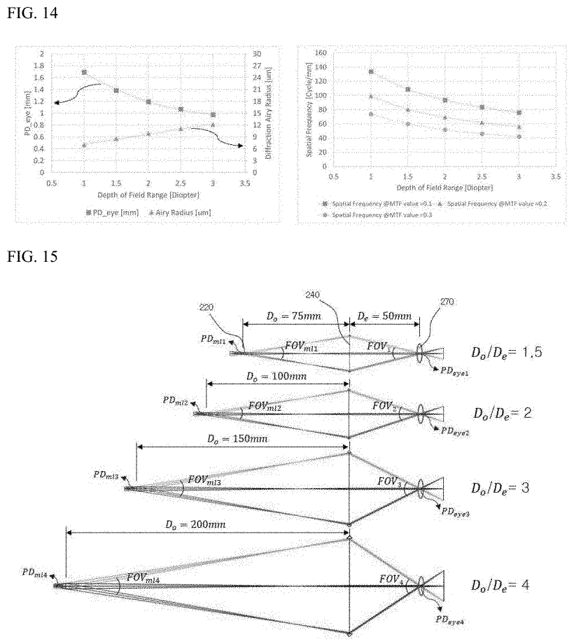

FIG. 14 is a set of graphs illustrating best condition characteristics according to the DOF range according to the embodiment of the present disclosure.

Referring to FIG. 14, in the embodiment of the present disclosure, key parameter conditions may be set as follows.

| | | | | Spatial | Spatial | Spatial |
|---|---|---|---|---|---|---|
| DOF | | Working | Diffraction | Frequency | Frequency | Frequency |
| range | PD_eye | F/# (Best | Airy Radius | @MTF | @MTF | @MTF |
| [Diopter] | [mm] | focus) | [um] | value = 0.1 | value = 0.2 | value = 0.3 |
| 1 | 1.694 | 9.761 | 7 | 133.6 | 99 | 73.8 |
| 1.5 | 1.3825 | 11.96 | 8.57 | 108.6 | 80.4 | 60 |
| 2 | 1.197 | 13.81.4 | 9.9 | 93.6 | 69.4 | 51.8 |
| 2.5 | 1.071 | 15.489 | 11.07 | 83.4 | 61.8 | 46.2 |
| 3 | 0.9776 | 16.914 | 12.12 | 75.9 | 56.2 | 42 |

An optimum structure of a virtual image generating optical system in which the ratio Dₒ/Dₑ of the distance Dₒ and the distance Dₑ is 2:1 may be set such that the distance Dₒ is 100 mm and the distance Dₑ is 50 mm. In addition, as for the optimum condition, distance D_{img} between virtual image and convergence area may be set to satisfy the same condition as the best accommodation position D_{best} of virtual image and satisfy the arithmetic mean position of the DOF range in diopters. In practical use conditions, it is preferable to be set such that most far accommodation position D_{f} of eye is 0 diopters (=infinity in meters), but when the set DOF range of the virtual image is the same even in the condition of most far accommodation position D_{f} of eye is not 0 diopters, the same characteristics as the above characteristics may be exhibited.

The optimization characteristic analysis results according to the DOF range according to the present embodiment will be described as follows.

In an optical system design satisfying the condition of distance D_{img}=DOF/2 of virtual image, when the condition in which the size of the image blur due to diffraction while the observer sees the extreme position (near position or far position) is equal to the size of the geometrical image blur is considered as the best condition, as the set DOF of the virtual image increases, the size PD_{eye} of convergence areas formed at the position of the eye lens (or pupil), which is the best condition, tends to decrease.

On the other hand, the image blur due to diffraction has a characteristic that increases linearly as the set DOF range in diopter units increases. This means that the virtual image-forming optical system of the present disclosure may be optimized for each set DOF range but has the disadvantage that the resolution of the image that can be represented is reduced as the DOF range is increased.

More specifically, the optical system exhibits a characteristic in which the significant spatial frequency of the MTF is lowered. For an image observed through a specific optical system, an MTF value for a spatial frequency limit that is meaningful to an observer typically means 10 to 30% (corresponding to 0.1 to 0.3 in MTF values normalized to 1) of the MTF value. Of these, the characteristic of how the spatial frequency value, which becomes 10%, 20%, and 30% of the representative MTF value, varies depending on the DOF range, is important.

The spatial frequency that may be represented by the optical system with the same DOF range tends to increase as the MTF value decreases, and for the same MTF value, the spatial frequency tends to decrease as the DOF range increases.

Accordingly, the DOF range may be selected according to the resolution (i.e., the spatial frequency) that can be provided in the virtual image, which is determined by a display resolution used and a required FOV, which is the key requirement of the optical system.

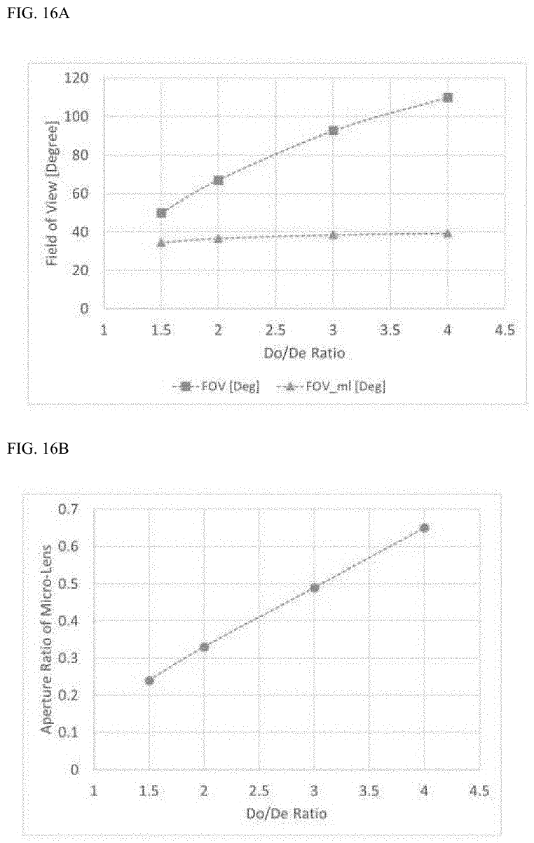

FIGS. 15 and 16 are diagrams illustrating a structure in which the FOV increases as the ratio of the distance between the optical element unit and the main optics lens and the distance between the main optics lens and the convergence area at the position of the pupil of the eye changes to 1.5 to 4 according to the embodiment of the present disclosure.

Referring to FIG. 15, the ratio Dₒ/Dₑ of the distance Dₒ between the optical element unit 220 and the main optics lens 240 and the distance Dₑ between the main optics lens 240 and the convergence area at the position of the pupil of the eye may be adjusted to be 1.5 to 4.

FIGS. 16A and 16B illustrate the change of the FOV as the distance ratio Dₒ/Dₑ is changed. Among key fixed parameters, the focal distance fₘₗ of the micro-lens may be set to 8 mm, the display size DS_{md} may be set to 6 mm, the DOF range may be set to 3 diopters (0 to 3 diopters), and the best accommodation position D_{best} of the virtual image may be set to 1.5 diopters (=666.7 mm).

The results of calculating and analyzing each best design condition by setting the parameters as described above and selecting four conditions between 1.5 and 4 for the ratio Dₒ/Dₑ of the distance Dₒ and the distance Dₑ are described as follows.

| Items | Condition 1 | Condition 2 | Condition 3 | Condition 4 |
|---|---|---|---|---|
| Do [mm] | 75 | 100 | 150 | 200 |
| De [mm] | 50 | | | |
| Do/De Ratio | 1.5 | 2 | 3 | 4 |
| F_mo [mm] | 30 | 33.3 | 37.5 | 40 |
| PD_eye [mm] | 0.9776 | | | |
| PD_ml [mm] | 1.4664 | 1.9552 | 2.9328 | 3.9104 |
| D_md [mm] | 9.667 | 9.06 | 8.6 | 8.414 |
| FOV_ml [Deg] | 34.48 | 36.64 | 38.46 | 39.25 |
| FOV [Deg] | 49.92 | 67.03 | 92.6 | 109.92 |
| FOV_ml/FOV | 1.45 | 1.83 | 2.41 | 2.8 |
| Ratio | | | | |
| Aperture Ratio | 0.24 | 0.33 | 0.49 | 0.65 |
| of Micro-Lens | | | | |

When the DOF range is determined, the best size PD_{eye} of the convergence area for a virtual image point group in the position of the eye lens is the same under four conditions.

An FOVₘₗ of a virtual image light source for each condition increases as the ratio of the distance Dₒ between the optical element unit 220 and the main optics lens 240 and the distance Dₑ between the main optics lens 240 and the convergence area 270 at the position of the pupil of the eye increases due to the design conditions and according to the difference in the distance D_{md} between the display unit 210 and the optical element unit 220, but the difference is not great. Under the conditions of the present embodiment, when the ratio Dₒ/Dₑ increases from 1.5 to 4, the FOVₘₗ of the virtual image light source increases by about a five degree angle.

On the other hand, referring to FIG. 16A, the FOV of the virtual image seen from the eye is increased 2.2 times from a 49.9 degree angle in an optical structure of Dₒ/Dₑ=1.5 to a 109.9 degree angle in an optical structure of Dₒ/Dₑ=4.

Further, referring to FIG. 16B, in the embodiment of the present disclosure, an area of the display unit 210 corresponding to one optical element unit 220 is used almost unchanged, and in a structure in which the ratio Dₒ/Dₑ increases, the best size PDₘₗ of the opening of the optical element unit increases. Accordingly, the ratio of the size PDₘₗ of the opening of the optical element unit compared to a display area increases as the ratio Dₒ/Dₑ increases.

That is, the pinhole (or pinhole array), which allows the size PDₘₗ of the opening of the micro-lens of the optical element unit to be set to an optimum value, may be used together with the micro-lens in the case of optimally designing a structure having a different Dₒ/Dₑ within the determined DOF range.

FIG. 17 is a set of graphs for describing conditions for obtaining the best size (or the size of the opening) of the optical element unit according to the designed DOF range when the optical system implements the same FOV according to the embodiment of the present disclosure.

FIGS. 17A and 17B illustrate a case in which the structure has the distance Dₒ of 100 mm, the distance Dₑ of 50 mm, the ratio Dₒ/Dₑ of 2:1, the designed FOV is a 40 degree angle, and a display screen ratio is 1:1.

The characteristics for best conditions are described as follows.

| DOF | | Working | Airy | | | |
|---|---|---|---|---|---|---|
| Range | PD_eye | F/# (Best | Radius | DS_md | | PD_ml/ |
| [Diopter] | [mm] | focus) | [um] | [mm] | PD_ml | DS_md |
| 1 | 1.694 | 9.761 | 7 | 3.298 | 3.388 | 1.03 |
| 13 | 1.3825 | 11.96 | 8.57 | | 2.765 | 0.84 |
| 2 | 1.2 | 13.779 | 9.88 | | 2.394 | 0.73 |
| 2.5 | 1.071 | 15.439 | 11.07 | | 2.142 | 0.65 |
| 3 | 0.9776 | 16.914 | 12.12 | | 1.9552 | 0.59 |

As the DOF range increases, the size PD_{eye} of the convergence area decreases, and accordingly, the size PDₘₗ of the opening of the optical element unit decreases so that a ratio PDₘₗ/DS_{md} of the size PDₘₗ of the opening of the micro-lens of the optical element unit and the display size DS_{md} decreases. In addition, the best size PD_{eye} of the convergence area is proportional to the ratio PDₘₗ/DS_{md}.

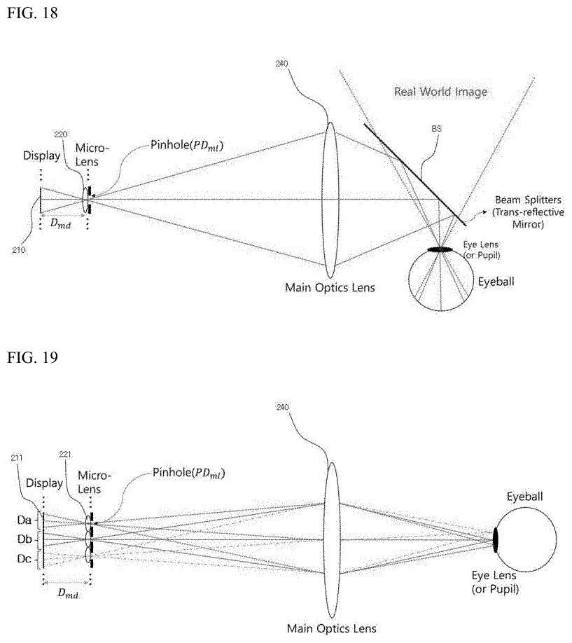

Hereinafter, examples in which the image display apparatus with an extended DOF of the present disclosure is applied in various ways will be described with reference to FIGS. 18 to 23. An image display apparatus with an extended DOF illustrated in FIGS. 18 to 23 has the same configuration as the image display apparatus with an extended DOF illustrated in FIG. 1, but detailed configurations to be changed or added are mainly illustrated in the drawings. That is, the basic structure of the present disclosure is based on the image display apparatus with an extended DOF shown in FIG. 1.

FIG. 18 illustrates a structure for an augmented reality (AR) application according to the embodiment of the present disclosure.

Referring to FIG. 18, in order to apply the image display apparatus with an extended DOF of the present disclosure to AR, an optical system should be configured such that an observer simultaneously observes an external real object (real-world image) and a virtual image.

To this end, a beam splitter BS disposed between the main optics lens 240 and the pupil of the eye and configured to change a path of light may be further included. The beam splitter BS may include, for example, a cubic beam splitter and a trans-reflective mirror that is disposed at a 45 degree angle and used. FIG. 18 illustrates an embodiment in which a trans-reflecting mirror is used, and unlike the image display apparatus with an extended DOF of FIG. 1, the eye of the observer may be disposed at a 90 degree angle with respect to an optical axis formed through the display unit and the main optics lens. Thus, the observer may simultaneously observe the virtual image reflected from the beam splitter and the real-world image that has passed through the beam splitter.

FIG. 19 is a diagram illustrating a configuration of an image display apparatus with an extended DOF according to another embodiment of the present disclosure.

Referring to FIG. 19, a display unit 210 according to the present embodiment may be formed in an array structure in which display areas 211 are arranged. In addition, an optical element unit 220 may be formed in an array structure in which micro-lenses 221 are arranged. When such a configuration is used, a 3D image may be implemented using parallax images converged at different positions of a pupil after passing through the array of the optical element unit 220 adjacent to the display unit 210.

According to the embodiment of the present disclosure, the display unit 210 composed of the display areas 211 and the optical element unit 220 composed of the micro-lenses 221 may be variously modified and used. That is, an image may be provided by dividing one display area 211 into a predetermined area corresponding to each of the micro-lenses 221 using the arrangement of display areas 211 and the micro-lenses 221 or using the arrangement of the display areas 211 and the arrangement of the micro-lenses 221.

When a method of providing a super multi-view 3D parallax image according to the present embodiment is briefly described, an area of the display unit 210 is divided into areas Dₐ, D_{b}, and Dₑ adjacent to each other, and light passes through the micro-lens 221 corresponding to the respective display areas 211 and converges at a position of a pupil of an eye through a main optics lens 240. At this point, parallax images adjacent to each other for each display area 211 may be recorded.

Each of the parallax images moves a predetermined distance from the position of the pupil of the eye to form a convergence area of the image. In the present embodiment, an interval between adjacent convergence areas is preferably formed within 2 mm in order to implement the super multi-view parallax image.

That is, a size PD_{eye} of a convergence area set at the position of the pupil of the eye may be 2 mm or less, and in this case, a DOF range may be increased, thereby providing a comfortable and clear 3D image. Although an example in which three parallax images are provided has been described in the present embodiment, of course, three or more micro-lenses 221 may be additionally configured in a horizontal or vertical direction to implement a full parallax image.

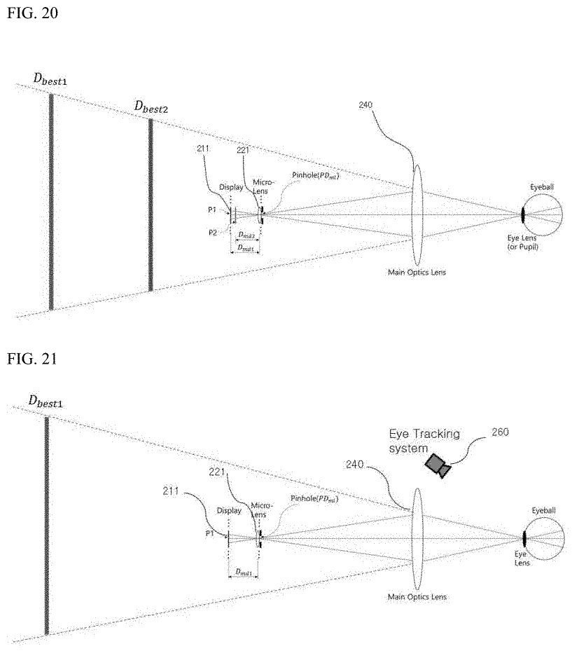

FIG. 20 is a diagram illustrating a configuration of an image display apparatus with an extended DOF according to still another embodiment of the present disclosure and illustrates an application of changing a best accommodation position of a virtual image.

Referring to FIG. 20, a fine adjustment device (not shown) configured to adjust a distance D_{md} between a display unit 211 and an optical element unit 221 may be further included. The fine adjustment device adjusts the distance D_{md} between the display unit 211 and the optical element unit 221, thereby enabling a user to conveniently use one optical system according to whether the user mainly sees a far virtual image or a near virtual image.

At this point, the distance D_{md} between the display unit 211 and the optical element unit 221 may be automatically adjusted using an additional electrical control device or may be adjusted by manually controlling a precision mechanical moving device.

In FIG. 20, it can be seen that the best accommodation position of the virtual image is formed at “D_{best1}” when the distance between the display unit 211 and the optical element unit 221 is “D_{md1},” and the best accommodation position of the virtual image may be formed at “D_{best2},” when the distance between the display unit 211 and the optical element unit 221 is “D_{md2}.”

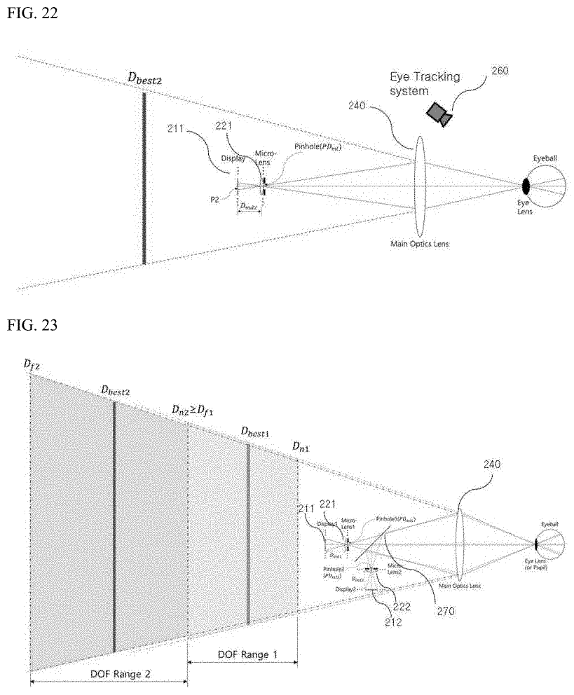

FIGS. 21 and 22 are diagrams illustrating a configuration of an image display apparatus with an extended DOF according to yet another embodiment of the present disclosure and illustrate a case in which focal distance information of an eye of an eye-tracking system 260 is used to change a best accommodation position of a virtual image.

The image display apparatus with an extended DOF shown in FIGS. 21 and 22 is the same as the image display apparatus with an extended DOF shown in FIG. 1 and further includes the eye-tracking system 260. Referring to FIGS. 21 and 22, a control unit (not shown) may receive the focal distance information of the eye from the eye-tracking system 260 and adjust a distance D_{md} between a display unit 211 and an optical element unit 221 using a fine adjustment device (not shown) according to the focal distance information of the eye.

For example, referring to FIG. 21, when a focal distance of the eye tracked by the eye-tracking system 260 is “D_{best1},” the distance between the display unit 211 and the optical element unit 221 may be changed to “D_{md1},” thereby forming the virtual image at a position of the focal distance of the eye. In addition, referring to FIG. 22, when the focal distance of the eye is “D_{best2},” the distance between the display unit 211 and the optical element unit 221 is changed to “D_{md2}” by feeding back the focal distance of the eye. Accordingly, even when an observer changes a gaze depth, a user may continuously see a comfortable and clear virtual image. In the present embodiment, the focal distance of the eye is tracked through the eye-tracking system 260 so that the virtual image is formed at the corresponding position, but as another embodiment, only two virtual image positions D_{best1} and D_{best2} are set and used, and the distance between the display unit and the optical element unit may be selectively changed so that, among the two virtual image positions, a position close to the focal distance measured by the eye-tracking system 260 is selected.

FIG. 23 is a diagram illustrating a configuration of an image display apparatus with an extended DOF according to yet another embodiment of the present disclosure, in which two display units 211 and 212 are disposed at a 90 degree angle to each other, and a beam splitter 270 may be disposed between the two display units.

Referring to FIG. 23, an image display apparatus with an extended DOF, which has two DOF ranges, may be implemented using the two display units. However, of course, at least two display units 211 and 212 may be disposed, and two or more best accommodation positions of a virtual image may also be disposed. In addition, of course, at least two display units may use various angles of arrangement structure as well as a 90 degree angle depending on the design of the image display apparatus.

Distances between the display units 211 and 212 and optical element units 221 and 222 may be set to “D_{md1},” and “D_{md2},” respectively. A size PDₘₗ of an opening of each of the optical element units 221 and 222 may be set to “PDₘₗ₁” and “PDₘₗ₂.” At this point, the best accommodation positions of the virtual image are formed at “D_{best1}” and “D_{best2}.”

The present embodiment will be described on the assumption that “D_{best1}” is formed at a position further inward than “D_{best2}.” Here, a case in which a DOF Range 1 of a first virtual image and a DOF range 2 of a second virtual image are disposed adjacent to each other without overlapping each other is shown in FIG. 23, which is a case of Dₙ₂=Dₙ₁.

In this case, the DOF range of the image display apparatus with an extended DOF according to the embodiment is extended to a sum of the DOF range 1 of the first virtual image and the DOF range 2 of the second virtual image so that a DOF of the virtual image may be further extended.

Preferably, two virtual image sources may be set such that some DOF ranges overlap in order to mitigate an image blur at a boundary of the two virtual images. In this case, a far position DOF range D_{f1} of the first virtual image is formed further outward than a near position DOF range Dₙ₂ of the second virtual image. That is, Dₙ₂>D_{f1} in units of diopters.

In the present embodiment, it is possible to control two pieces of virtual image information having different DOF ranges to be simultaneously utilized so that a user may conveniently see a virtual image of an extended DOF range. In addition, an eye-tracking system is additionally applied to the present embodiment to selectively operate only a virtual image that is close to a focal distance of an eye by receiving feedback of a tracked focal distance of the eye.

According to the present disclosure, a multifocal 3D image display apparatus with an extended depth of focus DOF can be implemented by optimizing a diffraction limit and a geometrical image blur of an optical system in a retina by forming a convergence area of a parallax image at a position of a pupil of an eye so that a size thereof is less than a minimum pupil size.

The scope of the present disclosure described above is not limited to the description and representation of the embodiments explicitly described above. Further, it is added once again that the scope of the present disclosure is not limited by any obvious changes or substitutions in the art to which the disclosure belongs.

What is claimed is:

1. A method of controlling an image display apparatus with an extended depth of focus (DOF), which comprises a display unit, an optical element unit disposed to be spaced apart from a front surface of the display unit by a predetermined distance (D_{md}) and including a lens and a pinhole that has an opening portion (PDₘₗ), a main optics lens disposed to be spaced apart from a front surface of the optical element unit by a predetermined distance (Dₒ) and configured to form a convergence area of a virtual image on a pupil of an eye of a user, and a control unit that performs a control for extending a DOF with respect to the virtual image provided to the user,
wherein the control unit adjusts a size of the convergence area, which is formed from an image point of the virtual image, at a position of the pupil of the eye so that a size of a near position image blur of the image point, which is formed on a retina, at a most near accommodation position of the eye, is equal to a size of a far position image blur of the image point, which is formed on the retina, at a most far accommodation position of the eye.

2. The method of claim 1, wherein the control unit adjusts the size of the convergence area, which is formed from the image point of the virtual image, at the position of the pupil of the eye so that a best position of the image point of the virtual image becomes an arithmetic mean position of the most near accommodation position of the eye and the most far accommodation position of the eye in units of diopters.

3. The method of claim 1, wherein the control unit adjusts the size of the convergence area, which is formed from the image point of the virtual image, at the position of the pupil of the eye so that the size of each of the near and far position image blurs is within +/−20% of the same value as a size of an image blur due to diffraction.

4. The method of claim 1, wherein the control unit adjusts the distance (D_{md}) between the front surface of the display unit and the optical element unit and/or a size of the pinhole of the optical element unit.

5. The method of claim 1, wherein the most far accommodation position of the eye is zero in units of diopters.

6. The method of claim 1, wherein the size of the convergence area at the position of the pupil of the eye is 2 mm or less.

7. The method of claim 1, wherein a ratio of a distance between the optical element unit and the main optics lens and a distance between the main optics lens and the convergence area at the position of the pupil of the eye ranges from 1.5 to 4.

8. The method of claim 1, wherein
the display unit includes at least one or more micro-displays,
the lens and the pinhole of the optical element unit are disposed to correspond to the micro-displays, and
the control unit forms one or two or more convergence areas at the position of the pupil of the eye, wherein the two or more convergence areas are adjacent parallax images.

9. The method of claim 1, wherein the control unit adjusts the separation distance (D_{md}) between the display unit and the optical element unit to change a best position (D_{best}) of the image point of the virtual image.

10. The method of claim 1, wherein
the display unit includes at least two or more displays comprising a first display unit and a second display unit and, the optical element unit includes at least two or more optical element units comprising a first optical element unit and a second optical element unit,
the most near accommodation position of the eye includes a first most near accommodation position of the eye and a second most near accommodation position of the eye,
the most far accommodation position of the eye includes a first most far accommodation position of the eye and a second most far accommodation position of the eye, and
the control unit is configured to adjust a distance between a front surface of the first display unit and the first optical element unit and/or a size of a pinhole of the first optical element unit and a distance between a front surface of the second display unit and the second optical element unit and/or a size of a pinhole of the second optical element unit so that a size of a geometrical image blur of an image point, which is formed on the retina, at each of the first most near accommodation position of the eye and the first most far accommodation position of the eye is the same and a size of a geometrical image blur of an image point, which is formed on the retina, at each of the second most near accommodation position of the eye and the second most far accommodation position of the eye is the same, to adjust the size of the convergence area, which is formed from the image point of the virtual image, at the position of the pupil of the eye.

11. The method of claim 10, wherein the control unit controls the first most far accommodation position of the eye to be equal to or less than the second most near accommodation position of the eye in units of diopters so that the entire DOF range is extended between the second most far accommodation position of the eye and the first most near accommodation position of the eye.

12. An image display apparatus with an extended depth of focus (DOF), the apparatus comprising:
a display unit;
an optical element unit disposed to be spaced apart from a front surface of the display unit by a predetermined distance (D_{md}) and including a lens and a pinhole that has an opening portion (PDₘₗ);
a main optics lens disposed to be spaced apart from a front surface of the optical element unit by a predetermined distance (Dₒ) and configured to form a convergence area of a virtual image on a pupil of an eye of a user; and
a control unit that performs a control for extending a DOF with respect to the virtual image provided to the user,
wherein the control unit adjusts a size of the convergence area, which is formed from an image point of the virtual image, at a position of the pupil of the eye so that a size of a near position image blur of the image point, which is formed on a retina, at a most near accommodation position of the eye is equal to a size of a far position image blur of the image point, which is formed on the retina, at a most far accommodation position of the eye.

13. The apparatus of claim 12, wherein
the display unit has an array structure in which micro-displays are arranged adjacent to each other, and
the optical element unit has an array structure in which micro-lenses and pinholes, of which openings are adjustable, that correspond to the micro-displays are arranged adjacent to each other.

14. The apparatus of claim 13, wherein
one or two or more convergence areas are formed at a position of the pupil of the eye using the micro-displays and the micro-lenses, and
the two or more convergence areas are adjacent parallax images.

15. The apparatus of claim 12, wherein the optical element unit or the main optics lens includes a plurality of lenses.

16. The apparatus of claim 12, further comprising a beam splitter disposed between the main optics lens and the pupil of the eye and configured to change a path of light,
wherein the user simultaneously observes a virtual image reflected from the beam splitter and a real-world image that has passed through the beam splitter.

17. The apparatus of claim 12, further comprising a fine adjustment device configured to adjust the separation distance between the display unit and the optical element unit to change a best position (D_{best}) of the image point of the virtual image.

18. The apparatus of claim 17, further comprising an eye-tracking system configured to provide focal distance information of the eye,
wherein the control unit adjusts the separation distance (D_{md}) between the display unit and the optical element unit according to the focal distance information of the eye.

19. The apparatus of claim 17, further comprising an eye-tracking system configured to provide focal distance information of the eye,
wherein two virtual image positions (D_{best1} and D_{best2}) are set and used, and
the control unit selectively adjusts the separation distance (D_{md}) between the display unit and the optical element unit so that, among the two virtual image positions, a position close to a focal distance measured by the eye-tracking system is selected.

20. The apparatus of claim 12, wherein
the display unit includes at least two or more displays, and
each of the most near accommodation position of the eye and the most far accommodation position of the eye includes two or more.

21. The apparatus of claim 20, wherein
the display unit includes a first display unit and a second display unit disposed perpendicular to the first display unit, and
a beam splitter is disposed between the first display unit and the second display unit.

22. The apparatus of claim 20, wherein
the most near accommodation position of the eye includes a first most near accommodation position of the eye and a second most near accommodation position of the eye,
the most far accommodation position of the eye includes a first most far accommodation position of the eye and a second most far accommodation position of the eye,
a size of a geometrical image blur of an image point, which is formed on the retina, at each of the first most near accommodation position of the eye and the first most far accommodation position of the eye is the same, and
a size of a geometrical image blur of an image point, which is formed on the retina, at each of the second most near accommodation position of the eye and the second most far accommodation position of the eye is the same.

23. The apparatus of claim 22, wherein the first most far accommodation position of the eye is equal to or less than the second most near accommodation position of the eye in units of diopters so that the entire DOF range is extended between the second most far accommodation position of the eye and the first most near accommodation position of the eye.

24. The apparatus of claim 20, further comprising an eye-tracking system configured to provide focal distance information of the eye,
wherein the control unit selectively operates a virtual image that is close to a focal distance of the eye according to the focal distance information of the eye.

25. The apparatus of claim 12, wherein the control unit adjusts the size of the convergence area, which is formed from the image point of the virtual image, at the position of the pupil of the eye so that a best position of the image point of the virtual image becomes an arithmetic mean position of the most near accommodation position of the eye and the most far accommodation position of the eye in units of diopters.

26. The apparatus of claim 12, wherein the control unit adjusts the size of the convergence area, which is formed from the image point of the virtual image, at the position of the pupil of the eye so that the size of each of the near and far position image blurs is within +/−20% of the same value as a size of an image blur due to diffraction.

27. The apparatus of claim 12, wherein a ratio of a distance between the optical element unit and the main optics lens and a distance between the main optics lens and the convergence area at the position of the pupil of the eye ranges from 1.5 to 4.

28. The method of claim 2, wherein the control unit adjusts the distance (D_{md}) between the front surface of the display unit and the optical element unit and/or a size of the pinhole of the optical element unit.

29. The method of claim 3, wherein the control unit adjusts the distance (D_{md}) between the front surface of the display unit and the optical element unit and/or a size of the pinhole of the optical element unit.
